(19) United States
(12) Patent Application Publication
(10) Pub. No.: US 2016/0288816 A1
(43) Pub. Date: Oct. 6, 2016

(54) STEERING ASSEMBLY

(71) Applicant: SAINT-GOBAIN PERFORMANCE PLASTICS CORPORATION, Solon, OH (US)

(72) Inventor: Stuart Kelly, Shanghai (CN)

(21) Appl. No.: 15/086,374

(22) Filed: Mar. 31, 2016

Related U.S. Application Data
(60) Provisional application No. 62/141,128, filed on Mar. 31, 2015.

(51) Int. Cl. B62D 1/16

(52) U.S. Cl. CPC B62D 1/16

(57) ABSTRACT

A steering assembly including an input shaft having a bore along an axial end; an output shaft having a bore along an axial end; a torque bar extending into and operatively coupled to the bores of the input and output shafts; and a bearing assembly disposed between the torque bar and one of the input and output shafts, the bearing assembly including: a low friction layer; and a tolerance ring coupled to the low friction layer and extending radially therefrom.

### CROSS-REFERENCE TO RELATED APPLICATION(S)

This application claims priority under 35 U.S.C. §119(e) to U.S. Patent Application No. 62/141,128 entitled “Steering Assembly,” by Stuart Kelly, filed Mar. 31, 2015, which is assigned to the current assignee hereof and incorporated herein by reference in its entirety.

### FIELD OF THE DISCLOSURE

The present disclosure relates to steering assemblies, and more particularly to bearing assemblies in electric powered steering assemblies.

### RELATED ART

Typical electric power steering (EPS) systems include a user engageable steering wheel connected to a shaft, including an upper shaft and a lower shaft connected together by a torque bar. The torque bar may be held to the upper or lower shafts by a pin or frictional engagement. The upper shaft is coupled to the steering wheel and the lower shaft is coupled to a rack and pinion gear of a vehicle. Angular displacement of the upper shaft causes the torque bar to twist, or angularly deflect. A torque sensor measures the angular displacement of the torque bar and sends a signal to a controller that instructs a motor to begin operating. The motor, connected to the lower shaft, angularly displaces the lower shaft a calculated angular distance, assisting the driver in turning the road wheels of the vehicle. The automotive industry continues to demand improved EPS systems.

### BRIEF DESCRIPTION OF THE DRAWINGS

Embodiments are illustrated by way of example and are not limited in the accompanying figures.

FIG. 1 includes a cross-sectional elevation view of a steering assembly in accordance with an embodiment.

FIG. 2 includes an enlarged cross-sectional view of the steering assembly in accordance with an embodiment.

FIG. 3 includes a cross-sectional elevation view of the steering assembly in accordance with an embodiment as seen along Line A-A in FIG. 2.

FIG. 4 includes a cross-sectional elevation view of the steering assembly in accordance with an embodiment as seen along Line A-A in FIG. 2.

FIG. 5 includes a perspective view of a bearing assembly in accordance with an embodiment.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the steering assembly and tolerance ring arts.

A steering assembly in accordance with one or more embodiments described herein can include an input shaft having a bore along an axial end, an output shaft having a bore along an axial end, a torque bar extending into and operatively coupled to the bores of the input and output shafts, and a bearing assembly disposed between the torque bar and at least one of the input and output shafts. In an embodiment, the bearing assembly can include a low friction layer and a tolerance ring coupled to the low friction layer and extending radially therefrom. In another embodiment, the bearing assembly requires at least 1 kg of force to install on the torque bar, input shaft, or output shaft. In a further embodiment, the bearing assembly can have a unitary construction such that the bearing assembly is devoid of discrete rotatable elements, such as ball bearings, needle bearings, or the like. That is, the bearing assembly can include a single piece without moving objects. In an embodiment, a bearing having a unitary construction can include more than one layer or component, however, the layers or components are attached together such that only nominal relative motion between the layers occurs. In a particular instance, the bearing is a plain bearing.

In yet another embodiment, the bearing assembly forms a zero-clearance fit between the torque bar and at least one of the input and output shafts. Use of a steering assembly in accordance with one or more of the embodiments described herein can dampen road vibration and reduce rattle that is typically associated with the use of needle bearings, while providing a smoother driver experience. Additionally, embodiments of the present steering assembly can provide torque overload protection and more regulated driving characteristics.

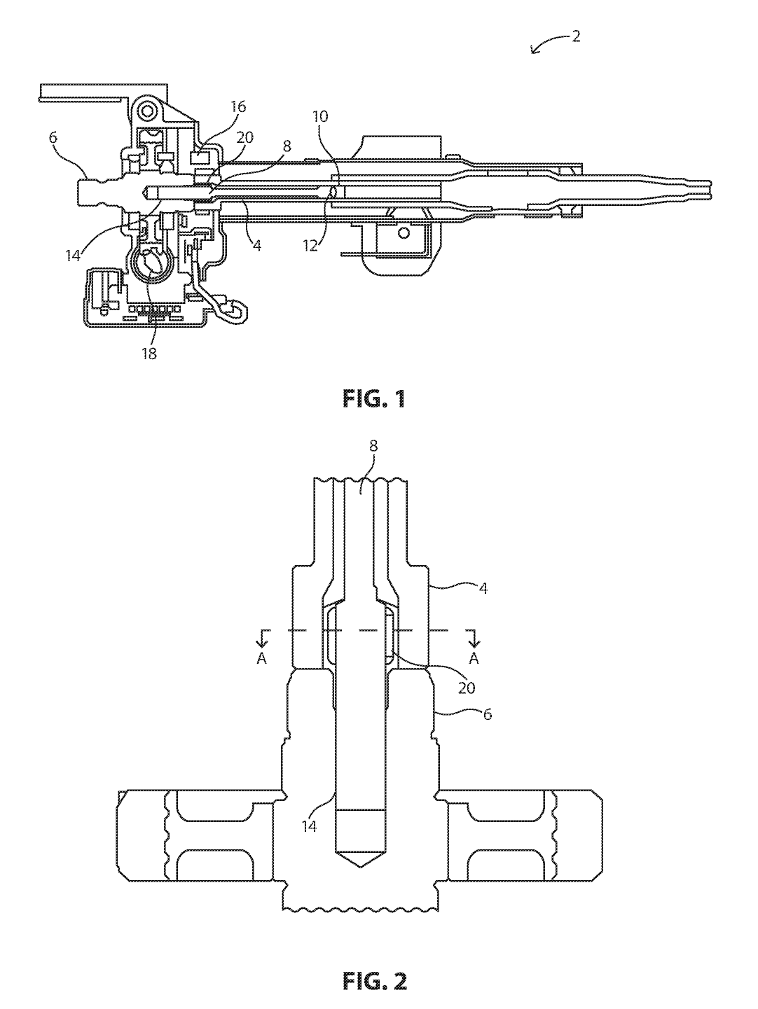

Referring initially to FIGS. 1 and 2, a steering assembly 2 generally includes an input shaft 4 and an output shaft 6 operative coupled together. The input shaft 4 can be coupled to a steering wheel (not illustrated) which may permit rotational displacement of the steering assembly 2. The steering wheel can include a traditional steering wheel as found in passenger vehicles, a joystick, or any other suitable arrangement for user input of a directional correction.

The input shaft 4 can be coaxially coupled to the output shaft 6 by a torque bar 8 such that rotational displacement of the input shaft 4 is transmitted to the output shaft 6 through the torque bar 8 within a predetermined range. As illustrated, one end 10 of the torque bar 8 can be coupled to the input shaft 4 by a pin 12, or the like, and the other end 14 of the torque bar 8 can be coupled to the output shaft 6 by a pin (not illustrated), or the like. In an embodiment, the torque bar 8 can be frictionally coupled to at least one of the input and output shafts 4 and 6. That is, engagement between the torque bar 8 and one of the input or output shafts 4 or 6 can occur through frictional resistance.

A bearing assembly 20 can be disposed between the torque bar 8 and one or both of the input and output shafts 4 and 6. In an embodiment, the bearing assembly 20 is disposed between the torque bar 8 and the input shaft 4. In a non-illustrated embodiment, the bearing assembly can be disposed between the torque bar and the output shaft. In yet another embodiment, a first bearing assembly can be disposed between the torque bar and the input shaft, and a second bearing assembly can be disposed between the torque bar and the output shaft.

The bearing assembly 20 provides a low friction interface between the torque bar 8 and one or both of the input and output shafts 4 and 6, thereby allowing angular deflection of the torque bar 8, i.e., elastic deformation detectable by a torque detection device 16, while maintaining proper coaxial alignment between the input and output shafts 4 and 6.

The torque detection device 16 can be coupled to the steering assembly 2 to detect and measure torque applied to the torque bar 8 from the input shaft 4. When the torque detection device 16 detects angular displacement of the torque bar 8 it can send a signal to a motor 18 to turn on accordingly. The motor 18 in turn provides an angular force to the output shaft 6 which in turn moves a gear arrangement (e.g., a rack and pinion gear) to turn the road wheels.

In an embodiment, the bearing assembly 20 can be installed on the torque bar 8 or one of the shafts 4 and 6 by an assembly force of at least 1 kg in a longitudinal direction relative to the torque bar 8, such as at least 2 kg, at least 3 kg, at least 4 kg, at least 5 kg, at least 10 kg, or even at least 15 kg. That is, unlike traditional needle bearings which are readily installable without application of significant, or even any, force, the bearing assembly 20 may not freely slide along the torque bar 8 or shafts 4 or 6. In a further embodiment, the bearing assembly 20 can be installed on the torque bar 8 or one of the shafts 4 and 6 by an assembly force of no greater than 20 kg in a longitudinal direction relative to the torque bar 8, such as no greater than 19 kg, no greater than 18 kg, no greater than 17 kg, or even no greater than 16 kg.

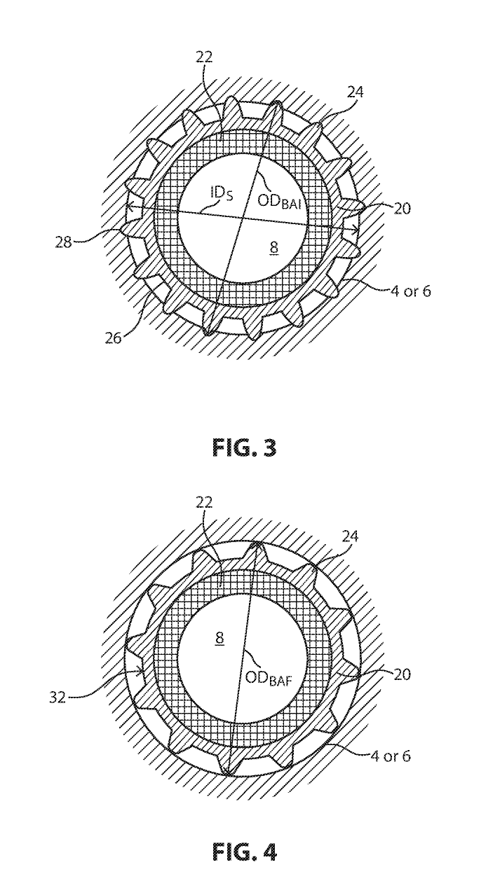

Referring now to FIG. 3, the bearing assembly 20 can include a low friction layer 22 and a tolerance ring 24 coupled to the low friction layer 22 and extending radially therefrom. As illustrated, the low friction layer 22 can form a radially innermost portion of the bearing assembly 20. In another embodiment, the low friction layer can form a radially outermost portion of the bearing assembly and the tolerance ring may be disposed radially inside of the low friction layer. That is, the bearing assembly 2 can operate in either relative radial configuration.

In an embodiment, the low friction layer 22 can include a low friction material. In a more particular embodiment, the low friction layer 22 can include a polymer having a low coefficient of friction. In an embodiment, the low friction layer 22 can include a material having a dry static coefficient of friction, μs, as measured against steel, of no greater than 0.5, such as no greater than 0.45, no greater than 0.4, no greater than 0.35, no greater than 0.3, no greater than 0.25, no greater than 0.2, no greater than 0.15, no greater than 0.1, or even no greater than 0.05. In an embodiment, μs can be no less than 0.01.

Exemplary polymers include polytetrafluoroethylene (PTFE), fluorinated ethylene-propylene (FEP), polyvinylidenfluoride (PVDF), polychlorotrifluoroethylene (PCTFE), ethylene chlorotrifluoroethylene (ECTFE), perfluoroalkoxy alkane (PFA), polyacetal, polybutylene terephthalate (PBT), polyethylene terephthalate (PET), polyimide (PI), polyetherimide, polyetheretherketone (PEEK), polyethylene (PE), polysulfone, polyamide (PA), polyphenylene oxide, polyphenylene sulfide (PPS), polyurethane, polyester, liquid crystal polymers (LCP), or any combination thereof. In accordance with a particular embodiment, the low friction layer 22 includes a fluoropolymer.

In an embodiment, the low friction layer 22 further includes at least one filler. The filler can enhance the slip interface of the low friction layer 22. Exemplary fillers include glass fibers, carbon fibers, silicon, PEEK, aromatic polyester, carbon particles, bronze, fluoropolymers, thermoplastic fillers, aluminum oxide, polyamidimide (PAI), PPS, polyphenylene sulfone (PPSO2), LCP, aromatic polyesters, molybdenum disulfide, tungsten disulfide, graphite, grapheme, expanded graphite, boron nitrade, talc, calcium fluoride, or any combination thereof. Additionally, the filler can include alumina, silica, titanium dioxide, calcium fluoride, boron nitride, mica, Wollastonite, silicon carbide, silicon nitride, zirconia, carbon black, pigments, or any combination thereof.

In a particular embodiment, the low friction layer 22 can be coupled to a backing layer (not illustrated), or substrate, to enhance rigidity and structural support. The low friction layer 22 can be applied to the backing layer by a coating technique, such as for example, physical or vapor deposition, spraying, plating, powder coating, or through other chemical or electrochemical techniques. In a certain embodiment, the low friction layer 22 can be sintered to the backing layer. In a particular embodiment, the low friction layer 22 may be applied by a roll-to-roll coating process, including for example, extrusion coating. The low friction layer 22 can be heated to a molten or semi-molten state and extruded through a slot die onto a major surface of the backing layer. In another embodiment, the low friction layer 22 can be cast or molded. In an embodiment, the low friction layer 22 can be pressed or rolled to the backing layer. In a particular embodiment, pressing or rolling can occur at elevated temperatures, i.e., the low friction layer 22 is hot-pressed or rolled. In some embodiments, an adhesive layer (not illustrated) can be disposed between the low friction layer 22 and the backing layer. In a particular embodiment, the low friction layer 22 is coupled to the tolerance ring 24 such that the backing layer is disposed radially between the tolerance ring 24 and the low friction layer 22.

In another embodiment, the low friction layer 22 is not coupled to a backing layer, but instead only coupled to the tolerance ring 24. The low friction layer 22 can be coupled to the tolerance ring 24 by any method described with respect to the engagement between the backing layer and the low friction layer. For example, the low friction layer 22 can be applied to the tolerance ring 24 by a coating technique, such as for example, physical or vapor deposition, spraying, plating, powder coating, or through other chemical or electrochemical techniques. In a certain embodiment, the low friction layer 22 may be sintered to the tolerance ring 24. In a particular embodiment, the low friction layer 22 can be applied by a roll-to-roll coating process, including for example, extrusion coating. The low friction layer 22 can be heated to a molten or semi-molten state and extruded through a slot die onto a major surface of the tolerance ring. In another embodiment, the low friction layer 22 can be cast or molded. In an embodiment, the low friction layer 22 can be pressed or rolled to the tolerance ring 24. In a particular embodiment, pressing or rolling can occur at elevated temperatures, i.e., the low friction layer 22 is hot-pressed or rolled. In some embodiments, an adhesive layer (not illustrated) is disposed between the low friction layer 22 and the tolerance ring 24.

In accordance with at least one embodiment described herein, the tolerance ring 24 can include an annular band 26 and a plurality of projections 28 extending radially from the annular band 26. The tolerance ring 24 can include a resilient material, such as a metal. In a particular embodiment, the tolerance ring 24 can include, or consist essentially of, steel. In a more particular embodiment, the tolerance ring 24 can include, or consist essentially of, spring steel.

In an embodiment, the tolerance ring 24 can be monolithically formed from a single piece of material. The projections 28 can be stamped or otherwise formed in the piece of material. The tolerance ring 24 can then be rolled to a cylindrical, or generally cylindrical, shape, with the projections 28 extending radially inward or radially outward as desired.

By way of a non-limiting example, the tolerance ring 24 can include at least 3 projections 28 extending radially from the annular 26, such as at least 4 projections, at least 5 projections, at least 6 projections, at least 7 projections, at least 8 projections, at least 9 projections, or even at least 10 projections. The projections 28 can be evenly spaced apart in a circumferential direction around the tolerance ring 24. In a non-illustrated embodiment, each projection can include a plurality of projections extending in an axial direction. That is, each projection can include a plurality of smaller projections at least partially occupying a similar footprint as the previously described projection.

In an embodiment, a circumferentially extending band 34 can space the projections 28 apart from an axial end 38 of the tolerance ring 24. In a further embodiment, a circumferentially extending band 36 can space the projections 28 apart from an axial end 40 of the tolerance ring 24.

In an embodiment, the bearing assembly 20 can have an initial, preinstalled outer diameter, OD_{BAI}, as measured by a best fit circle prior to installation, greater than an inner diameter, ID_{S}, of the input or output shaft 4 or 6. In an embodiment, OD_{BAI} is at least 1.01 ID_{S}, such as at least 1.02 ID_{S}, at least 1.03 ID_{S}, at least 1.04 ID_{S}, at least 1.05 ID_{S}, at least 1.1 ID_{S}, at least 1.2 ID_{S}, at least 1.3 ID_{S}, at least 1.4 ID_{S}, or even at least 1.5 ID_{S}. In a further embodiment, OD_{BAI} can be no greater than 3.0 ID_{S}, such as no greater than 2.5 ID_{S}, or even no greater than 2.0 ID_{S}. In another embodiment, OD_{BAI} can be within a range of 1.01 ID_{S} and 3.0 ID_{S}, such as in a range of 1.02 ID_{S} and 2.5 ID_{S}, in a range of 1.03 ID_{S} and 2.0 ID_{S}, or even in a range of 1.04 ID_{S} and 1.5 ID_{S}. In FIG. 3, all of the plurality of projections 28 are illustrated extending into the input or output shaft 4 or 6 as they would appear in an undeformed state, prior to installation between the torque bar 8 and the input or output shaft 4 or 6.

The bearing assembly 20 can have a functional outer diameter, OD_{BAF}, as measured by a best fit circle after installation with the input or output shaft 4 or 6. In an embodiment, OD_{BAF} is less than OD_{BAI}. That is, the functional outer diameter of the bearing assembly 20 is less than the initial, preinstalled outer diameter thereof.

FIG. 4 includes a cross section view of the steering assembly 2 in the installed state, i.e., after installation of the bearing assembly 20 between the torque bar 8 and the input or output shaft 4 or 6. As illustrated in FIG. 4, the projections 28 are compressed between the torque bar 8 and the inner or outer shaft 4 or 6 as viewed in the installed state. In an embodiment, each of the projections 28 can have a radial stiffness of less than 1000 N/mm, such as less than 750 N/mm, less than 500 N/mm, less than 250 N/mm, less than 200 N/mm, less than 150 N/mm, less than 100 N/mm, less than 50 N/mm, less than 25 N/mm, less than 10 N/mm, less than 5 N/mm, less than 4 N/mm, less than 3 N/mm, less than 2 N/mm, or even less than 1 N/mm. The radial stiffness can be greater than 0 N/mm.

The amount of radial compression of the projections 28 can depend on the relative OD_{BAI} and ID_{S}. That is, as OD_{BAI} increases relative to ID_{S}, the projections 28 can radially compress a greater amount. This can permit use of the bearing assembly 20 in a relatively wide range of shaft sizes, thereby relaxing manufacturing tolerances of the input and output shafts 4 and 6, which may in turn reduce manufacturing costs.

For example, one bearing assembly 20 in accordance with embodiments described herein can be adapted for use with a shaft 4 or 6 having an ID_{S} standard deviation of up to±0.5 inches, such as a standard deviation of up to±0.4 inches, a standard deviation of up to±0.3 inches, or even a standard deviation of up to±0.2 inches. That is, the bearing assembly 20 can accommodate a range of shaft variability up to 0.5 inches. To the contrary, traditional bearing assemblies (e.g., needle bearings and ball bearings) used in typical steering assemblies are unable to absorb measurable misalignment or size variance caused by manufacturing tolerances as the bearing race is not adapted to operate over a perceptible size variance.

In an embodiment, the bearing assembly 20 forms a zero-clearance fit between the input and output shafts 4 and 6. As used herein, “zero-clearance fit” refers to alignment between two objects devoid of perceptible radial play, i.e., there is minimal or no relative movement exhibited between the aligned elements in a radial direction. “Zero-clearance” may be achievable, for example, when the in-use outer diameter of the bearing is equal to the in-use inner diameter of the input or output shaft 4 or 6 and when the in-use inner diameter of the bearing is equal to the in-use outer diameter of the torque bar 8. In a particular embodiment, a zero-clearance fit can eliminate rattle between the torque bar, the input shaft, and the output shaft. That is, lack of radial clearance and perceptible radial play can reduce or even eliminate rattle that may occur in those assemblies devoid of a bearing assembly or using a needle bearing.

The present disclosure is not intended to be limited to those embodiments illustrated in FIGS. 3 and 4. In a non-illustrated embodiment, the projections have staggered heights relative to one another. In a more particular embodiment, alternating projections can have alternating radial heights. In another more particular embodiment, at least three of the projections can have a first radial height and the remaining projections can have a second radial height different than the first radial height. Skilled artisans should understand that the bearing assembly can have an opposite radial arrangement, i.e., the low friction layer is disposed radially outside of the tolerance ring and projection of the tolerance ring extend radially inward.

In an embodiment, an exposed radial surface 32 of the tolerance ring 24 can include a second low friction layer (not illustrated). The second low friction layer can include a material similar to the low friction layer 22. In a more particular embodiment, the second low friction layer can include, or consist essentially of, a fluoropolymer.

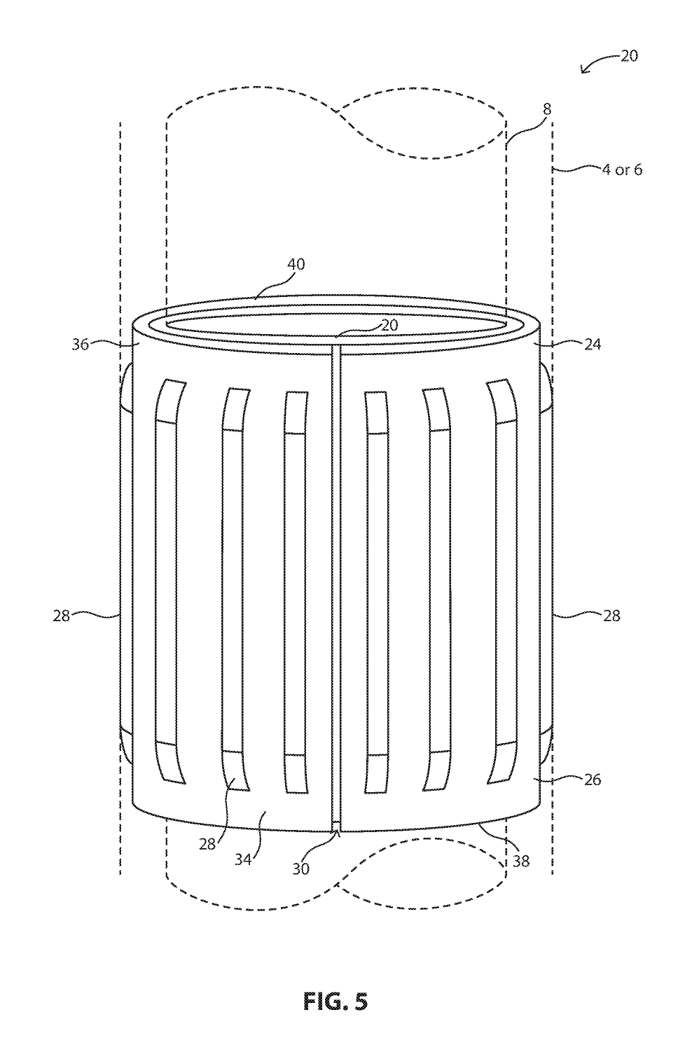

Referring to FIG. 5, the tolerance ring 24 can be formed as a split ring, i.e., the tolerance ring 24 includes an axially extending gap 30. In an embodiment, the low friction layer can include a similar axially extending gap (not illustrated). In a more particular embodiment, the axially extending gap of the low friction layer can circumferentially align with the axially extending gap of the tolerance ring. In another more particular embodiment, the axially extending gap of the low friction layer can be circumferentially offset from the axially extending gap of the tolerance ring. In another embodiment, the low friction layer 22 can be devoid of an axially extending gap. That is, the low friction layer 22 can include an unbroken cylindrical body.

In an embodiment, the tolerance ring 24 can have an axial length, L_{TR}, as measured between axial ends 38 and 40, of no greater than an axial length, L_{LFL,} of the low friction layer 22, as measured between axial ends of the low friction layer 22. For example, in an embodiment L_{TR} can be no greater than 1.0 L_{LFL,} such as no greater than 0.99 L_{LFL}, no greater than 0.98 L_{LFL}, no greater than 0.97 L_{LFL}, no greater than 0.96 L_{LFL,} no greater than 0.95 L_{LFL}, no greater than 0.9 L_{LFL,} or even no greater than 0.8 L_{LFL}. In an embodiment, L_{TR} can be no less than 0.2 L_{LFL}, such as no less than 0.25 L_{LFL}, no less than 0.3 L_{LFL}, or even no less than 0.3 L_{LFL}.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

### EMBODIMENT 1

A steering assembly comprising:
an input shaft having a bore along an axial end;
an output shaft having a bore along an axial end;
a torque bar extending into and operatively coupled to the bores of the input and output shafts; and
a bearing assembly disposed between the torque bar and one of the input and output shafts, the bearing assembly comprising:
a low friction layer; and
a tolerance ring coupled to the low friction layer and extending radially therefrom.

### EMBODIMENT 2

A steering assembly comprising:
an input shaft having a bore along an axial end;
an output shaft having a bore along an axial end;
a torque bar extending into and operatively coupled to the bores of the input and output shafts; and
a bearing assembly disposed between the torque bar and one of the input and output shafts,
wherein the bearing assembly requires an assembly force of at least 1 kg to install on the input or output shaft.

### EMBODIMENT 3

A steering assembly comprising:
an input shaft having a bore along an axial end;
an output shaft having a bore along an axial end;
a torque bar extending into and operatively coupled to the bores of the input and output shafts; and
a bearing assembly disposed between the torque bar and one of the input and output shafts, the bearing assembly comprising a unitary construction.

### EMBODIMENT 4

A steering assembly comprising:
an input shaft having a bore along an axial end;
an output shaft having a bore along an axial end;
a torque bar extending into and operatively coupled to the bores of the input and output shafts; and
a bearing assembly disposed between and forming a zero clearance with the torque bar and one of the input and output shafts.

### EMBODIMENT 5

The steering assembly of any one of the preceding embodiments, wherein the bearing assembly comprises:
a low friction layer; and
a tolerance ring coupled to the low friction layer and extending radially therefrom

### EMBODIMENT 6

The steering assembly of embodiment 5, wherein the low friction layer comprises a fluoropolymer.

### EMBODIMENT 7

The steering assembly of any one of embodiments 5 and 6, wherein the tolerance ring comprises:
an annular band; and
a plurality of projections extending radially from the annular band.

### EMBODIMENT 8

The steering assembly of embodiment 7, wherein the plurality of projections extend in a radial direction away from the low friction layer.

### EMBODIMENT 9

The steering assembly of any one of embodiments 7 and 8, wherein the plurality of projections have a radial stiffness/spring rate of less than 1000 N/mm, such as less than 750 N/mm, less than 500 N/mm, less than 250 N/mm, less than 200 N/mm, less than 150 N/mm, less than 100 N/mm, less than 50 N/mm, less than 25 N/mm, less than 10 N/mm, less than 5 N/mm, less than 4 N/mm, less than 3 N/mm, less than 2 N/mm, or even less than 1 N/mm.

### EMBODIMENT 10

The steering assembly of any one of embodiments 5-9, wherein the tolerance ring is disposed radially outside of the low friction layer.

### EMBODIMENT 11

The steering assembly of any one of embodiments 5-10, wherein the low friction layer is coupled to the tolerance ring by an adhesive.

### EMBODIMENT 12

The steering assembly of any one of embodiments 5-11, wherein the tolerance ring comprises an axially extending gap.

### EMBODIMENT 13

The steering assembly of any one of embodiments 5-12, wherein the low friction layer has an axial length, and wherein an axial length of the tolerance ring is no greater than the axial length of the low friction layer.

### EMBODIMENT 14

The steering assembly of any one of the preceding embodiments, wherein the bearing assembly has an initial outer diameter, OD_{BAI}, as measured by a best fit circle prior to installation, and a functional outer diameter, OD_{BAF}, as measured by a best fit circle after installation, and wherein OD_{BAF} is less than OD_{BAI}.

### EMBODIMENT 15

The steering assembly of any one of the preceding embodiments, wherein the bearing assembly comprising a unitary construction.

### EMBODIMENT 16

The steering assembly of any one of the preceding embodiments, wherein the bearing assembly requires an assembly force of at least 1 kg to install on the input or output shaft, such as at least 2 kg to install, at least 3 kg to install, at least 4 kg to install, at least 5 kg to install, at least 10 kg to install, or even at least 15 kg to install.

### EMBODIMENT 17

The steering assembly of any one of the preceding embodiments, wherein the bearing assembly requires an assembly force of no greater than 20 kg to install on the input or output shaft, such as no greater than 19 kg to install, no greater than 18 kg to install, no greater than 17 kg to install, or even no greater than 16 kg to install.

### EMBODIMENT 18

The steering assembly of any one of the preceding embodiments, wherein a maximum thickness of the bearing assembly, as measured by a radial distance between a radially innermost point and a radially outermost point, is less in the installed state as compared to prior to installation.

### EMBODIMENT 19

The steering assembly of any one of the preceding embodiments, wherein the bearing assembly is adapted for use with an input or output shaft having an inner diameter, ID_{S}, and wherein the bearing assembly is adapted for use with an ID_{S} standard deviation of up to±0.5 inches, such as a standard deviation of up to±0.4 inches, a standard deviation of up to±0.3 inches, or even a standard deviation of up to±0.2 inches

### EMBODIMENT 20

The steering assembly of any one of the preceding embodiments, wherein the input shaft is operatively coupled to a steering wheel adapted to be operatively controlled by a user.

Note that not all of the features described above are required, that a portion of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range, including the end range values referenced. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

What is claimed is:

1. A steering assembly comprising:
an input shaft having a bore along an axial end;
an output shaft having a bore along an axial end;
a torque bar extending into and operatively coupled to the bores of the input and output shafts; and
a bearing assembly disposed between the torque bar and one of the input and output shafts, the bearing assembly comprising:
a low friction layer; and
a tolerance ring coupled to the low friction layer and extending radially therefrom.

2. The steering assembly of claim 1, wherein bearing assembly comprises a plain bearing.

3. The steering assembly of claim 1, wherein the tolerance ring comprises:
an annular band; and
a plurality of projections extending radially from the annular band.

4. The steering assembly of claim 3, wherein the plurality of projections extend in a radial direction away from the low friction layer.

5. The steering assembly of claim 3, wherein the plurality of projections have a radial stiffness/spring rate of less than 1000 N/mm.

6. The steering assembly of claim 3, wherein the tolerance ring comprises an axially extending gap.

7. The steering assembly of claim 1, wherein the bearing assembly is adapted to be assembled on the input or output shaft upon application of a force of no greater than 20 kg.

8. The steering assembly of claim 1, wherein the bearing assembly is adapted for use with an input or output shaft having an inner diameter, ID_{S}, and wherein the bearing assembly is adapted to be used with an input or output shaft having an ID_{S} standard deviation of up to±0.5 inches.

9. The steering assembly of claim 1, wherein the bearing assembly comprises a unitary construction.

10. A steering assembly comprising:
an input shaft having a bore along an axial end;
an output shaft having a bore along an axial end;
a torque bar extending into and operatively coupled to the bores of the input and output shafts; and
a bearing assembly disposed between the torque bar and one of the input and output shafts, the bearing assembly comprising a unitary construction.

11. The steering assembly of claim 10, wherein the bearing assembly comprises:
a low friction layer; and
a tolerance ring coupled to the low friction layer and extending radially therefrom.

12. The steering assembly of claim 11, wherein the tolerance ring comprises:
an annular band; and
a plurality of projections extending radially from the annular band.

13. The steering assembly of claim 12, wherein the plurality of projections have a radial stiffness/spring rate of less than 1000 N/mm, and wherein the tolerance ring comprises an axially extending gap.

14. The steering assembly of claim 12, wherein the bearing assembly comprises a unitary construction.

15. A steering assembly comprising:
an input shaft having a bore along an axial end;
an output shaft having a bore along an axial end;
a torque bar extending into and operatively coupled to the bores of the input and output shafts; and
a bearing assembly disposed between and forming a zero clearance with the torque bar and one of the input and output shafts.

16. The steering assembly of claim 15, wherein the bearing assembly comprises:
a low friction layer; and
a tolerance ring coupled to the low friction layer and extending radially therefrom

17. The steering assembly of claim 16, wherein the tolerance ring comprises:
an annular band; and
a plurality of projections extending radially from the annular band.

18. The steering assembly of claim 17, wherein the plurality of projections extend in a radial direction away from the low friction layer.

19. The steering assembly of claim 18, wherein the plurality of projections have a radial stiffness/spring rate of less than 1000 N/mm and an assembly force of no greater than 20 kg to install on the input or output shaft.

20. The steering assembly of claim 19, wherein the bearing assembly is adapted for use with an input or output shaft having an inner diameter, ID_{S}, and wherein the bearing assembly is adapted to be used with an input or output shaft having an ID_{S} standard deviation of up to±0.5 inches.
